(19) United States
(12) Patent Application Publication
(10) Pub. No.: US 2015/0054204 A1
(43) Pub. Date: Feb. 26, 2015

(54) Additive Manufacturing Microwave Systems And Methods

(71) Applicant: ESCAPE DYNAMICS INC., Broomfield, CO (US)

(72) Inventors: Dmitriy Tseliakhovich, Broomfield, CO (US); Tak Sum Chu, Broomfield, CO (US)

(21) Appl. No.: 14/470,912

(22) Filed: Aug. 27, 2014

Related U.S. Application Data
(60) Provisional application No. 61/870,784, filed on Aug. 27, 2013.
(60) Provisional application No. 61/870,211, filed on Aug. 26, 2013.

(51) Int. Cl. B29C 67/00

(52) U.S. Cl. CPC B29C 67/0088; B29C 67/0066; B29C 67/0077
USPC 264/489; 425/162

(57) ABSTRACT

A system for manufacturing a 3-dimensional object comprises a print head that is configured and disposed for depositing one or more material layers in a prescribed manner on a printing table. At least one of the material layers comprises two or more materials. A source of microwave energy is disposed and configured for directing a beam of microwave energy toward the work-piece in a prescribed manner. A controller is operatively coupled to the print head and the source of microwave energy. The controller is configured for causing the print head to deposit the one or more material layers in the prescribed manner and for causing the source of microwave energy to direct the beam of microwave energy toward the work-piece in the prescribed manner. A method for manufacturing a 3-dimensional object comprises depositing one or more material layers in a prescribed manner on a printing table and directing a beam of microwave energy toward the work-piece in a prescribed manner.

### RELATED APPLICATIONS

This application claims priority to U.S. Patent Application No. 61/870,211 filed Aug. 27, 2013, and to U.S. Patent Application No. 61/870,784, filed Aug. 27, 2013, both of which are incorporated herein by reference.

### BACKGROUND

Additive manufacturing processes are used to produce three-dimensional objects. Layers of material are deposited and bonded together (optionally onto an object or a substrate) according to a prescribed pattern or design to create a 3-dimensional (3D) object. A 3D printer implements this printing process by depositing a layer of material, in the form of one of a liquid, a powder, an extrusion (e.g., wire) and a sheet, onto a pre-existing object or substrate and subsequently fuses, by the focused application of energy, some or all of the material to the pre-existing object or substrate according to the prescribed pattern. The process repeats to deposit and fuse multiple layers (each layer representing a cross section through the object) to form the 3D object.

With these 3D printers, the vertical (Z axis) resolution is determined by the thickness of each deposited and fused layer. The accuracy with which material is deposited and fused in the X-Y plane defines the X-Y resolution. Improvements in 3D printers are typically driven by the goal to increase resolution in both the X-Y plane and the Z-axis, typically resulting in resolutions of 300 dots-per-inch in the X-Y plane and 20 μm in the Z axis.

Existing 3D printing processes, such as selective laser melting (SLM), direct metal laser sintering (DMLS), selective laser sintering (SLS), fused deposition modeling (FDM), stereo-lithography (SLA), laminated object manufacturing (LOM), electron beam melting (EBM), stereo-lithography (STL), and digital light processing (DLP) have several drawbacks and limitations. For example, there is a trade-off between equipment and material costs, object resolution, speed, and properties of the finished object. Typically, compromises are required in order to achieve specific project objectives. For example, to address the costs associated with 3D printing of metal objects, a non-metallic object may first be created using 3D printing and then used to produce a mold for casting metal copies. Laser-based 3D printing processes for metallic and ceramic parts are often slow and unreasonably expensive. Although resolution of such laser devices is high, the speed of generating the object is slow because the laser beam is narrowly focused and has a small diameter requiring rapid movement (scanning) across each deposited layer, which often results in non-uniform heat distribution, poor fusing, and inconsistent mechanical properties between different parts. Moreover, penetration of the laser beam into certain materials is limited, resulting in the thickness of each added layer being impracticably small.

Other methods of applying heat during the sintering portions of additive manufacturing processes entail a number of drawbacks and limitations. For example, in sintering, beams derived from frequencies in the range of approximately 2.45 GHz (i.e., wavelengths approximately equal to 12.22 cm) sources may be used. The energy distribution of such beams can be difficult to control, with the beam being excessively diffused and unfocussed. As a result, heat may be unintentionally applied outside of intended target areas, and precise control over depths of energy penetration can be impossible.

### SUMMARY OF THE INVENTION

In one embodiment, an additive manufacturing microwave system includes a beam shaping unit responsive to first instructions for manipulating raw microwave energy into shaped emission forming a first heating pattern within a heating chamber that implements desired heating of a first material deposited within the chamber. The system includes a controller for determining the first instructions based upon characteristics of the heating chamber and computer-aided manufacturing (CAM) data characterizing the desired heating and the first material.

In another embodiment, a microwave additive manufacturing method prints a first material as a first layer within a heating chamber and controls microwave energy to form a first heating pattern at the first material to change properties of the first material and to form a first part of a work-piece. A second material is deposited as a second layer on the first part, and microwave energy is controlled to form a second heating pattern at the second material to change properties of the second material and form a second part of the work-piece.

In another embodiment, a software product has instructions, stored on non-transitory computer-readable media, wherein the instructions, when executed by a computer, perform steps for implementing microwave additive manufacturing. The instructions include adjustable characteristics for a heating chamber, processing CAM data (including information for object shape and sequence), controlling a microwave beam control algorithm to generate beam control instructions for each step of the sequence, controlling depositing of material for each step of the sequence, and modeling distributed energy within the heating chamber as a function of the adjustable characteristics, beam control, and print control.

In another embodiment, a microwave additive manufacturing method includes forming, with a first heating pattern, a susceptor from a first material, and containing a second material within the susceptor as a mold to shape a second material with a second heating pattern.

In another embodiment, a microwave additive manufacturing method prints a first material and a second material within a heating chamber as a single layer, and controls microwave energy to form a first heating pattern at the single layer to change properties of the first and second materials such that at least part of a work-piece is formed by bonded first and second materials.

### BRIEF DESCRIPTION OF THE FIGURES

FIG. 1 shows one exemplary additive manufacturing microwave system, in an embodiment.

FIG. 2 shows two materials deposited onto a work-piece on a printing table, in an embodiment.

FIG. 3 shows a susceptor containing two materials during creation of a work-piece, in an embodiment.

FIG. 4 shows a controller for an additive manufacturing microwave system, in an embodiment.

FIG. 5 is a flowchart illustrating one exemplary method for microwave control during additive manufacturing, in an embodiment.

FIG. 6 shows one exemplary additive manufacturing microwave system that includes at least one beam wave coupling unit, in an embodiment.

FIG. 7 shows one exemplary additive manufacturing microwave system that includes a beam controller, in an embodiment.

FIG. 8 shows one exemplary beam shaping unit, in an embodiment.

FIG. 9 shows a heating pattern on one material deposited onto a work-piece on a printing table, in an embodiment.

FIG. 10 shows one exemplary microwave energy distribution along a heating pattern, in an embodiment.

FIG. 11 shows a heating pattern on two materials deposited onto a work-piece on a printing table, in an embodiment.

FIG. 12 shows one exemplary microwave energy distribution along a heating pattern, in an embodiment.

### DETAILED DESCRIPTION OF THE EMBODIMENTS

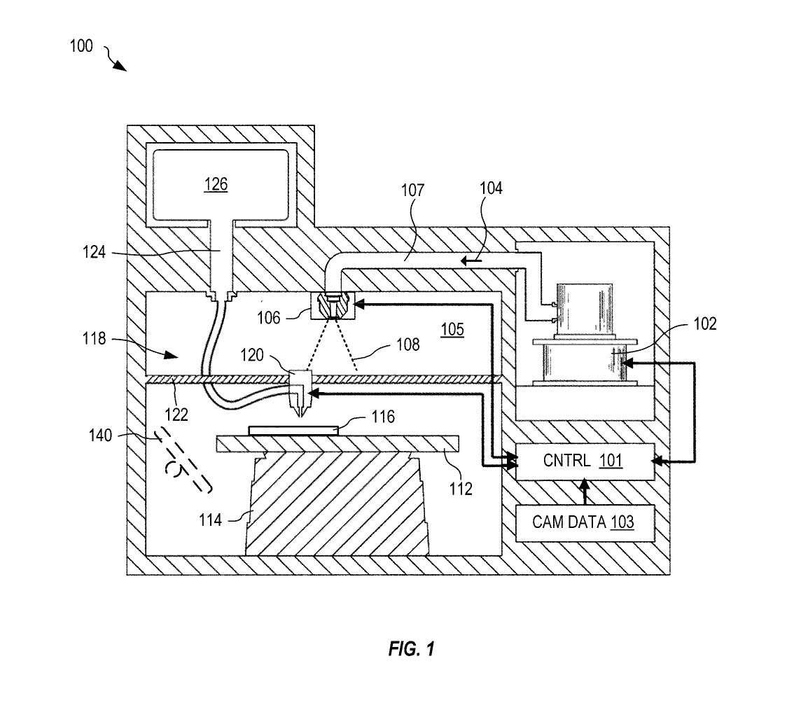

FIG. 1 shows one exemplary additive manufacturing microwave system 100. System 100 includes a millimeter wavelength integrated high-power microwave (HPM) source 102, which includes a microwave oscillator (e.g., a gyrotron) and an integrated power supply designed to power the microwave oscillator. HPM source 102 generates a raw microwave beam 104 directed to a beam shaping unit 106 through a waveguide 107. Integrated HPM source 102 generates raw microwave beam 104 (often referred to as a microwave/millimeter wave beam) with characteristics of between about 30 GHz and 300 GHz (e.g., wavelength of 1-10 mm), and at a power level of between about 2 kW and 2MW. The advantage of wavelengths in this range is the ability for precise and adjustable control. Often, raw microwave beam 104 has a frequency of between about 30 GHz and about 170 GHz at a power level between 20 kW and 100 kW. Gyrotrons operate efficiently at 30-170 GHz, and at power levels between 20 kW and 2MW. Power levels below 2 kW are insufficient to melt or sinter desired materials.

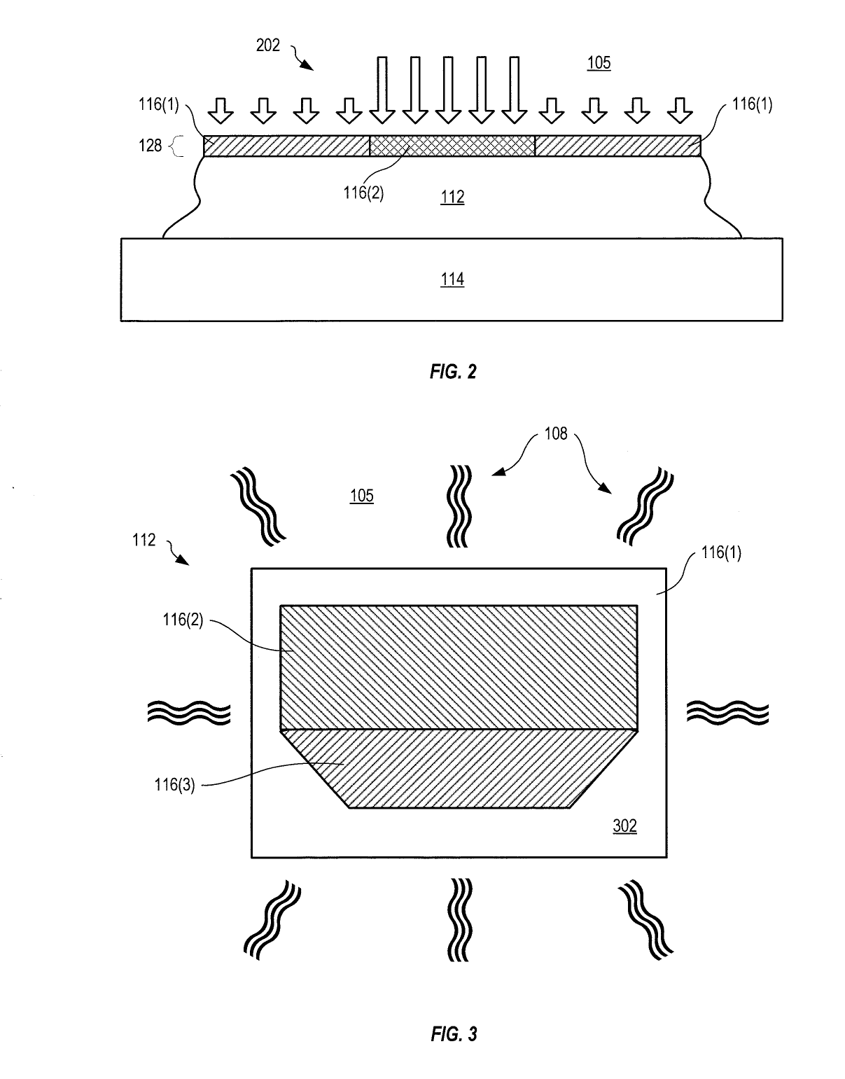

Beam shaping unit 106 manipulates raw microwave beam 104 to produce a shaped emission 108 directed to form a heating pattern (see heating pattern 202, FIG. 2) within a heating chamber 105 to heat one or more specific areas of a work-piece 112. A portion of work-piece 112 may be pre-fabricated prior to manipulation within system 100. A work-piece 112 may be a support structure for a deposited object and may be either reflective or absorptive as to form a susceptor.

System 100 includes a printer 118 that has a print head 120, supported by a print arm 122, that operates under control of a controller 101 to deposit one or more materials 116 within chamber 105. Print arm 122 may include rails that support translation of print head 120; alternatively it may include a robotic arm capable of movement in three directions along orthogonal axes (e.g., x-y-z). Additional print heads and/or print arms may be used without departing from the scope hereof; for example multiple print heads may facilitate deposition of two or more different materials 116 in a manner prescribed by computer-aided manufacturing (CAM) data 103.

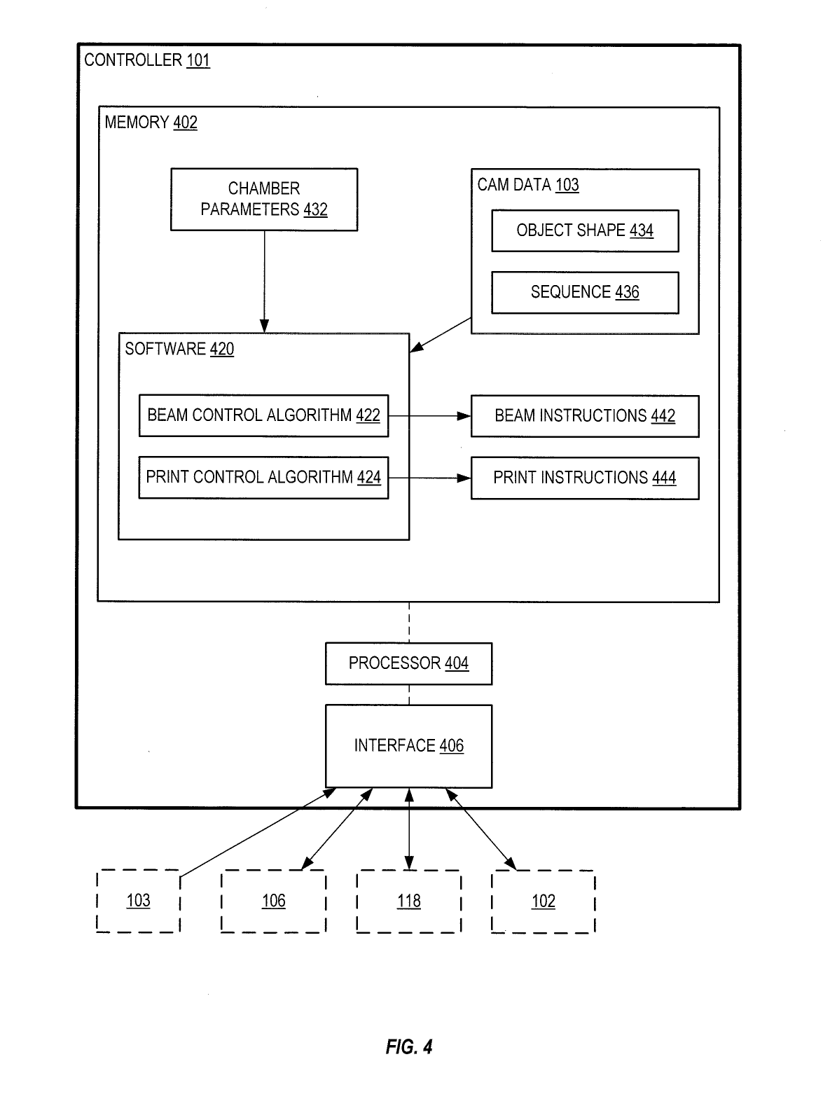

CAM data 103 is, for example, a set of processing instructions that includes a 3D model of a desired object (e.g., work-piece 112) generated by a computer-aided design (CAD) system or other suitable 3D design and modeling tool. CAM data 103 may include instructions for creating the designed objects from specific materials based upon operation of system 100. CAM data 103 may also define a susceptor (e.g., susceptor 302, FIG. 3) for molding and/or heating work-piece 112. In one embodiment, susceptor 302 is a mold. CAM data 103 may also specify heating and processing steps (e.g., sequence 436, FIG. 4) which involves formation, solidification and eventual removal (if needed) of the susceptor materials after the printing and sintering processes are complete.

Printer 118 receives one or more flows 124 of material 116 from a material hopper 126 and deposits one or more of these materials 116 as a layer 128 (see FIG. 2) onto one or both of a printing table 114 and work-piece 112 as defined within CAM data 103. The deposited precursor material may be in the form of a powder, slurry, solution, or any other form as defined by CAM data 103.

Material hopper 126 provides material 116 to print head 120 at a suitable rate to facilitate deposition of material layer 128 onto work-piece 112. Material hopper 126 may for example be a tray that supplies material 116. Print head 120 may be controlled (by controller 101) to deposit a material 116 layer with a uniform thickness such that material 116 is substantially planar. Or, in another embodiment, print head 120 is controlled by controller 101 to deposit material 116 with a non-uniform thickness such that material 116 has a defined topography and is non-planar.

Position and/or orientation of print head 120 are for example manipulated by one or more servo motors responsive to commands from controller 101. In an alternate embodiment, controller 101 receives signal(s) indicative of position at which the material 116 is deposited and uses that information in connection with producing commands suitable for instructing the printer to deposit the material 116 in a desirable manner (e.g., to create the desired object shape). Under control of controller 101, print head 120 may be moved in x-y-z directions via print arm 122 or via other activation mechanism.

Integrated HPM source 102 may include a compact power supply and the printer 118 may include a self-contained material supply such that system 100 may be provided as a fully self-contained unit. Alternatively, integrated HPM source 102 may be coupled to an external source of power and/or the printer may also be coupled to an external material supply such that system 100 is provided as a module to be coupled for operation within a larger manufacturing apparatus. This may be beneficial when system 100 is for example integrated into a CNC mill or a laser-based 3D printer.

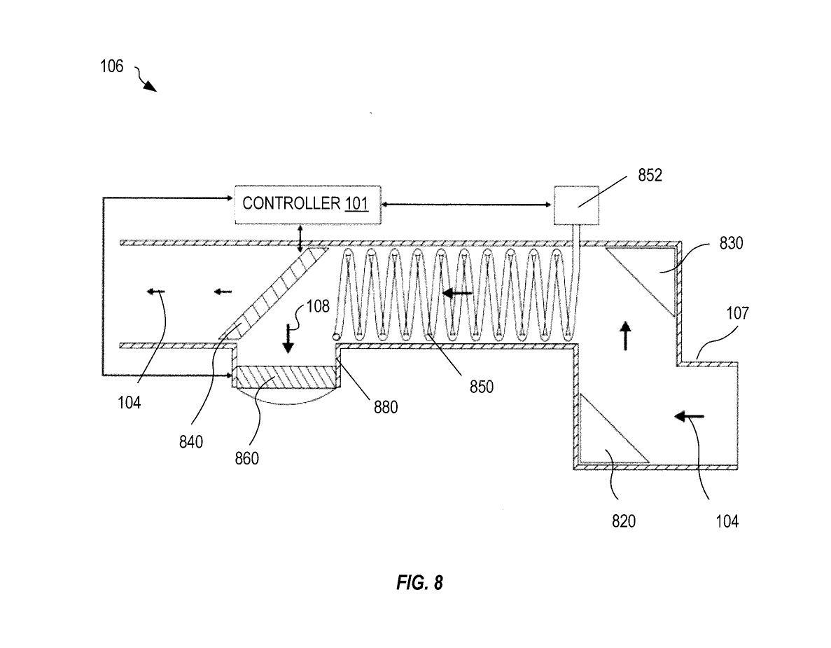

In an exemplary embodiment, beam shaping unit 106 includes one or more waveguides, beam formers, controllers, mirrors, beam phase manipulators, launchers, and/or beam isolators (see FIG. 8 for more detail). System 100 may include additional beam shaping units 106 without departing from the scope hereof, as discussed below.

Once material 116 has been deposited onto work-piece 112 within chamber 105, controller 101 then controls beam shaping unit 106 and integrated HPM source 102 to heat the deposited material 116, wherein material 116 is fused with work-piece 112. Subsequently, a new layer of powder is applied and the process is repeated.

Material 116 may represent a wide range of powdered and liquefied materials suitable for being conveyed to the print head 120 and deposited therefrom to form work-piece 112. Exemplary materials are metallic powders, ceramic powders, and slurries containing precursor metals, ceramics or pre-ceramic polymers.

Multiple Materials

FIG. 2 shows two different materials 116(1) and 116(2) deposited onto work-piece 112 (on printing table 114), such as by print head 120 of FIG. 1, to form layer 128. Materials 116 may be also deposited on a work-piece 112 that is pre-fabricated or on a layer of cured material, or on a cured layer of susceptor which forms a mold for the new layer of precursor material(s). Work-piece 112 is thereby constructed from two or more materials 116 combined in a prescribed manner. Beam shaping unit 106 manipulates raw microwave beam 104 to produce shaped emission 108 directed to form a heating pattern 202 within a heating chamber 105 to heat one or more specific areas of materials 116(1) and 116(2). In the example of FIG. 2, heating pattern 202 is illustratively shown as arrows depicting heat applied to materials 116(1) and 116(2). As shown, larger arrows indicate greater heating is applied to material 116(2) that to material 116(1) through control of shaped emission 108 by beam shaping unit 106. Arrows do not represent flow of heat, since heating pattern 202 heats materials 116(1) and 116(2) directly.

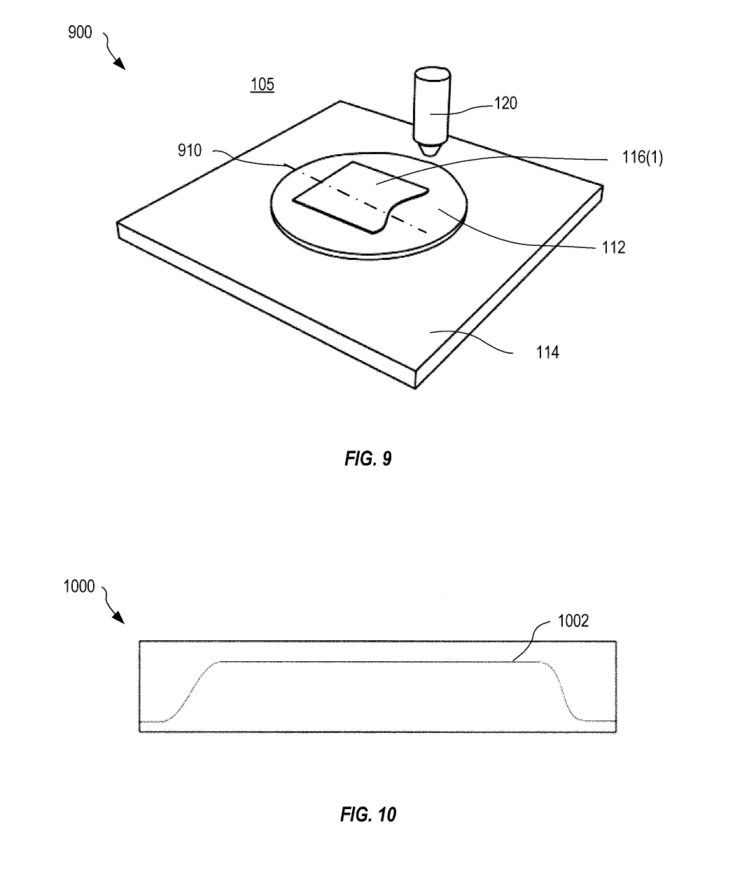

FIG. 9 is a perspective view showing exemplary deposition of material 116(1) by print head 120 as a layer onto work-piece 112 formed on printing table 114 within heating chamber 105. FIG. 10 shows an exemplary cross-section 1000 of heating pattern 202 as applied along line 910 of the example of FIG. 9. As indicated by line 1002 in cross section 1000, shaped emission 108 applies microwave energy uniformly across the deposited layer to provide uniform heating (as opposed to directed focused sintering).

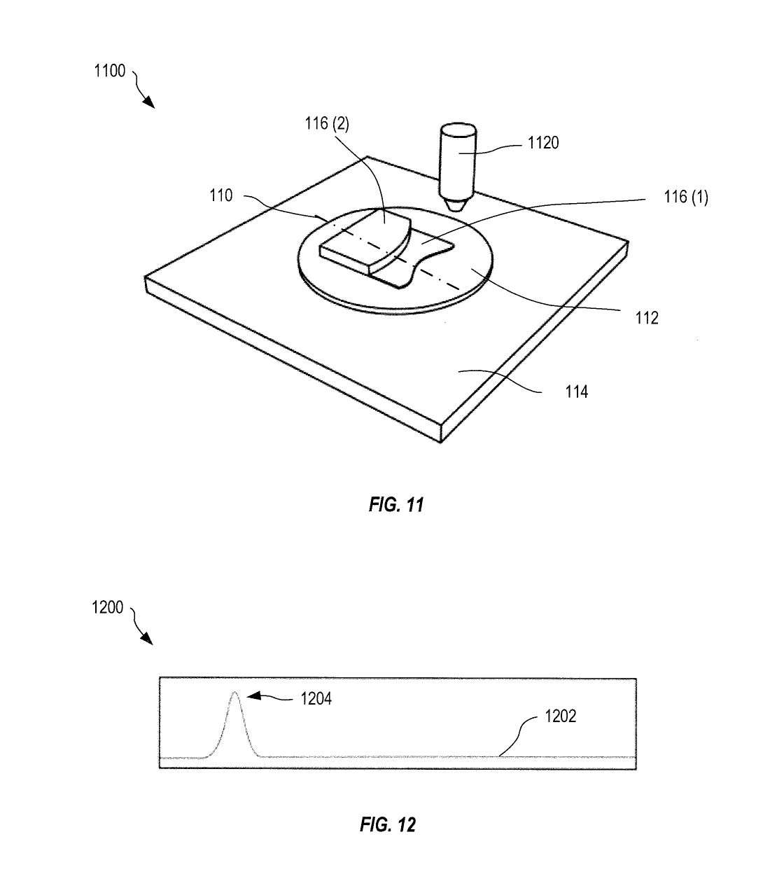

FIG. 11 is a perspective view showing exemplary deposition of material 116(2) by print head 120 as a layer onto previously deposited material 116(1). FIG. 12 shows an exemplary cross-section 1200 of heating pattern 202 as applied along line 1110 of the example of FIG. 11. As indicated by line 1202 in cross section 1200, shaped emission 108 is formed such that heating pattern 202 applies more heat, as indicated by peak 1204, directly to a small location of material 116(2) to cause sintering of that location while minimizing heating at other locations, such as of material 116(1) and work-piece 112. This heating pattern is distinct from that shown in FIGS. 9 and 10, where the heating is applied uniformly. The uniform heating may be beneficial for curing susceptor materials, or heating susceptor material when the metallic powder is deposited into the susceptor mold. The heating pattern shown in FIGS. 11 and 12 may be beneficial to sinter metallic powder and/or to create a joint between a ceramic work-piece and a newly added layer of metallic powder.

Different materials 116 may be selected for use together within chamber 105 based upon their different reactions when exposed to shaped emission 108. For example, material 116(1) may be more susceptible to heating from shaped emission 108 when generated at a first frequency and power level, and less susceptible to heating from shaped emission 108 when generated at a second frequency different from the first frequency, and/or a second power level different from the first power level.

Accordingly, controller 101 controls integrated HPM source 102 and beam shaping unit 106 to generate shaped emission 108 with first characteristics (e.g., beam size and power density) for heating material 116(1) and with a second set of characteristics (e.g., a different beam size and/or power density) to heat material 116(2). Since materials 116(1) and 116(2) react differently to shaped emission 108, each material 116 may be selectively treated by controller 101. In the case of high power microwave sources such as gyrotrons, operation at multiple frequencies is possible by modifications of the magnetic fields of magnets (e.g., super-conducting magnets) that are integral to operation of high power microwave sources and to the design of the resonating cavity of the microwave oscillator, such as a gyrotron, which support efficient microwave generation from multiple modes (e.g., first harmonic at 30 GHz and second harmonic at 60 GHz).

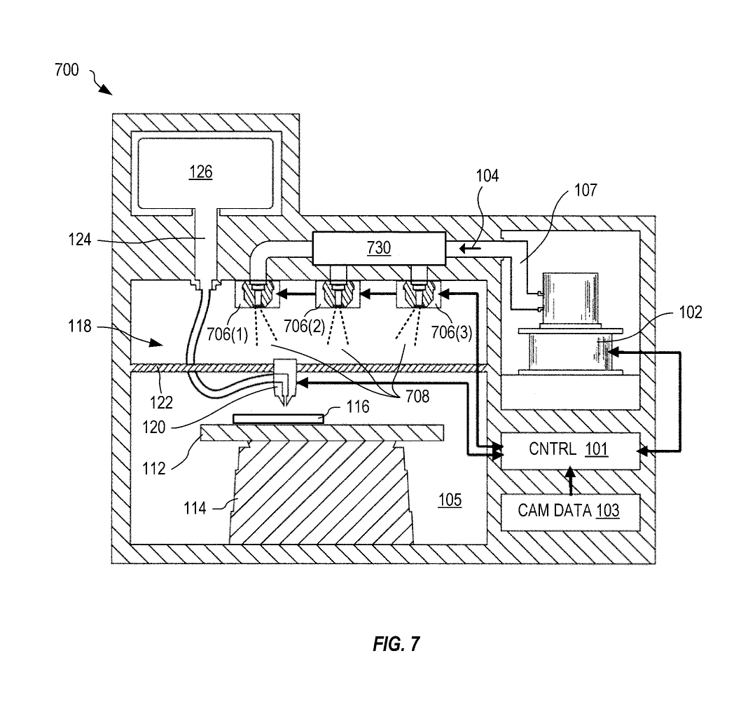

In one example of use shown in FIG. 3, materials 116 for susceptor 302 include synthetic diamond dust and titanium dioxide. This combination may provide desirable thermal characteristics due to the high thermal conductivity of the synthetic diamond dust and the superior mechanical/thermal properties due to the refractory nature of the titanium dioxide. In another example of use, susceptor material 116 includes alumina (AL2O3), which may be sintered to form susceptor 302; and then the alumina may be crushed into powder at the end of the production cycle and reused. In yet another example, mold susceptor material may be silicon carbide (SiC) or a mix of SiC with other materials such as castable SiC.

Where materials 116 include silver and Si3N4, shaped emission 108 may be configured with first characteristics having a frequency of 15-90 GHz (i.e., a free space wavelength of 2 cm-3 mm) at a power level from 10-100 kW range, where focus of shaped emission 108 is controlled to adjust the power density within chamber 105 (the output beam when focused may be assumed to be a circle of radius R with a power density calculated as integrated HPM source 102 output power divided by the area of the circular beam). Shaped emission 108 may be de-focused or several additional beams may be added (see FIG. 7) to provide maximum energy (i.e., heating) at a point of application through coherent interference in a desired location. System 100 may employ direct heating, where material 116 absorbs energy from shaped emission 108 and heats up; alternatively it may use shaped emission 108 to apply heat to a surrounding first material (e.g., material 116(1)), where a second material (e.g., material 116(2)) is heated by conduction of energy from the first material to the second material.

Where system 100 operates to process metals (e.g., stainless steel, copper, titanium, etc.) that are reflective, absorption may not be sufficient to heat the metal. Therefore, a susceptor of a different material (e.g., a mix of titanium dioxide and synthetic diamond dust, or a mix of alumina and/or other materials) may be deposited adjacent the metal to provide conductive heating.

System 100 may thus produce work-piece 112 from dissimilar materials 116 (e.g., metals and/or ceramics), where joining of these materials 116 is accomplished to combine advantages of brazing and 3D printing.

System 100 may also fabricate large metallic and ceramic work-pieces with quality and complexity that cannot be achieved with any single existing production technique. This capability is enabled by the wavelength of microwaves, the ability of microwave to be controlled with beam shaping units 106, the ability of microwave source 102 to operate at distinct frequencies and power densities, and the current knowledge of microwave-material interactions as represented in CAM data 103 and through real-time modeling and simulation of the environment in heating chamber 105 and on the work-piece 112.

Mold Material

FIG. 3 shows exemplary use of material 116(1) to form a susceptor 302 to contain materials 116(2) and 116(3) where it is desirable to mold and/or heat materials 116(2) and 116(3) by material 116(1) during different stages of creating work-piece 112. For example, materials 116(2) and 116(3) may be subsequently deposited within the mold formed by material 116(1). In another embodiment, material 116(2) is deposited adjacent to susceptor material 116(1), wherein application of shaped emission 108 heats material 116(1) which then heats material 116(2).

In the example of FIG. 3, layers of material 116(1) are deposited to form susceptor 302 with an inner region (i.e., a three dimensional structure) such that other materials 116(2) and 116(3) may be deposited therein. Controller 101 controls integrated HPM source 102 and beam shaping unit 106 to generate shaped emission 108 with first characteristics (e.g., a particular beam size and/or power density) to fuse or otherwise affect material 116(1) of the outer region without significantly affecting materials 116(2) and 116(3). Material 116(1) may shield materials 116(2) and 116(3) from shaped emission 108 such that they are unaffected (i.e., do not undergo phase change) by shaped emission 108 operating with the first characteristics.

Controller 101 may subsequently control integrated HPM source 102 and beam shaping unit 106 to generate shaped emission 108 with second characteristics (e.g., a different beam size and/or power density) that affects one or both of materials 116(2) and 116(3) in a desired manner. Material 116(1) and/or second characteristics of shaped emission 108 may be selected such that material 116(1) is unaffected by shaped emission 108 configured with the second characteristics for this subsequent processing, or may be selected such that material 116(1) is affected differently by shaped emission 108 having second characteristics. Accordingly, controller 101 may process selected regions of work-piece 112 individually and in a desired order based upon materials 116 and by controlling characteristics of shaped emission 108.

Consider one example of operation where different regions of work-piece 112 each require different heat treatments, such as maintaining a first region at a first temperature to facilitate fusing of first material (e.g., material 116(2)) and controlling temperature of a second region (e.g., material 116(3)) to grow crystalline structures over a defined period of time. Controller 101 thereby controls integrated HPM source 102 and beam shaping unit 106 to generate shaped emission 108 with appropriate characteristics to apply energy to each different material 116 and region of work-piece 112 as required. Thus, objects having spatially varying (e.g., directionally variable) properties may be created by system 100. After the printing and heating processes are complete, susceptor 302 may be removed.

In one embodiment, printer 118 is configured for extrusion-based deposition of susceptor materials (e.g., material 116(1)) to form susceptor 302 for creating work-piece 112. Beam shaping unit 106 is configured to transmit shaped emission 108 from a direction such that print head 120 experiences only minimal interference from shaped emission 108.

When used for microwave sintering of susceptor 302, material 116(1) may be selected to tolerate high temperatures (e.g., a ceramic material) so as to facilitate sintering of metallic powders deposited within susceptor 302. In such cases, material 116(1) may require curing and/or sintering prior to deposition of materials 116(2) and 116(3) within susceptor 302. Accordingly, material 116(1) may be applied in layers and cured by application of shaped emission 108 with first characteristics, and then materials 116(2) and 116(3) may be deposited within susceptor 302 and then sintered by application of shaped emission 108 having second characteristics (e.g., a different frequency and/or power level from the first characteristics).

Alternatively, susceptor 302 may be formed without the use of microwave sintering. Susceptor 302 may be cured and solidified at room temperature or may remain non-solidified until the final sintering process takes place. This method is for example applicable to fabrication of metals and ceramics with low melting temperatures.

In yet another example of operation, susceptor 302 may be deposited from a tray via a roller and solidified through application of shaped emission 108 (e.g., microwave sintering/curing) layer by layer. In this embodiment, a tray with material 116(1) is located adjacent to the area where the part is produced, wherein the roller picks up a pre-determined amount of material and spreads it in the area where the part will be produced. Shaped emission 108 is then controlled to create the pattern needed to form susceptor 302. After each layer of susceptor 302 is deposited and cured, material 116(2) and/or 116(3) is deposited into the mold formed by susceptor 302. Materials 116(2) and/or 116(3) may be deposited either by a roller or by print head 120 controlled with print arm 122. In this example, layer materials 116(1) and 116(2) and/or 116(3) are built up simultaneously.

Where materials 116 are deposited using printer 118, as described above, shaped emission 108 is applied with characteristics having an energy level below the amounts needed to sinter materials 116(2) and 116(3), but sufficient to solidify material 116(1). Thus, susceptor 302 is formed around materials 116(2) and 116(3) allowing for formation of complex shapes. When susceptor 302 is ready, it is filled with materials 116(2) and/or 116(3), and shaped emission 108 having second characteristics is used to heat susceptor 302 and form work-piece 112 from materials 116(2) and/or 116(3) therein. For example, metallic or ceramic powder inside susceptor 302 is either sintered or melted, and then re-solidified when shaped emission 108 is turned off. In both cases a high quality uniform metallic or ceramic work-piece 112 is formed inside susceptor 302. After the process is complete, susceptor 302 may be removed and crushed back into powder for re-use.

It is important to note that characteristics of beam 104 and shaped emission 108 from integrated HPM source 102 during the final heating/sintering process may be (and in most cases is) different than characteristics of beam 104 and shaped emission 108 during heating/solidification of material of susceptor 302. In one example, first characteristics configure shaped emission 108 with narrow focusing at 90 GHz and a low energy level, and second characteristics configure shaped emission 108 with wide focusing at 30 GHz and a high energy level. The use of 30 GHz for shaped emission 108 provides a more even energy distribution, such as shown in FIG. 10. An even energy density distribution may be also achieved by modulating one or a plurality of beam shaping units 106. Modulation may be achieved by rapidly jittering so as to create a uniform time-average energy distribution.

Susceptor 302 may also be configured to guide energy of shaped emission 108 or to absorb energy of shaped emission 108.

Properties of Materials

It should be noted that an understanding of the interactions between electromagnetic waves, such as microwaves, and materials may be informed by Maxwell's equations, as shown below.

Electromagnetic waves and material interactions are governed by Maxwell's equations:

$$▽ \times \vec{E} = - \frac{\partial \vec{B}}{\partial t}$$

$$▽ \times \vec{H} = \frac{\partial \vec{D}}{\partial t} + \vec{J}$$

$$▽ \cdot \vec{D} = ρ$$

$$▽ \cdot \vec{B} = 0$$

The material properties of these interactions come through the constitutive relations:

\vec{B}=μ\vec{H}

\vec{D}=∈\vec{E}

∈ is the permittivity tensor for directional electric properties.

μ is the permeability tensor for directional magnetic properties.

To simplify our discussion, we assume non-magnetic material in a vacuum μ=μₒ; isotropic ∈ is a scalar not a tensor; time harmonics (∂/∂t)=jw, and plane wave. Furthermore, we assume source free material, no driven current \vec{j}, and stored charges ρ. Then the loss mechanism can be described by:

∇×\vec{H}=jω∈′\vec{E}+(ω∈″+ρ)\vec{E}

where, ∈=∈′+j∈″ for dielectric materials with loss due to dipoles re-orientation, and σ for conductive materials with loss due to “free” charge movements.

∈′ is the lossless permittivity, in vacuum ∈=∈′+∈0=8.854×10⁻¹² F/m. In other words, ∈′ is the loss free term (jω), ω∈″+σ is the loss term, and the loss tangent is the ratio between the loss to the lossless term:

$$tan δ = \frac{ω {ε}^{″} + σ}{ω {ε}^{′}}$$

For a plane wave, the wave vector is

$$k = ω {\sqrt{{με}^{′} } [ 1 - j ( \frac{{ε}^{″}}{{ε}^{′}} + \frac{σ}{ω {ε}^{′}} ) ]}^{1 / 2}$$

$${e}^{- j ( \vec{k} \cdot \vec{r} - ω t )}$$

| Material | ε′ | σ(s/m) | ε″ | ε″/ε′ |
|---|---|---|---|---|
| Copper | 1 | 5.8 × 10⁷ | 0 | |
| Silver | 1 | 6.17 × 10⁷ | 0 | |
| Brass | 1 | 1.57 × 10⁷ | 0 | |
| Boron Nitride | 4.7 | 0 | | 115 × 10⁻⁵ |
| Si₃N₄ | 7.84 | 0 | | 30 × 10⁻⁵ |
| Sapphire Al₂O₃ | 9.4 | 0 | | 20 × 10⁻⁵ |
| PACVD Diamond | 5.67 | 0 | | 2 × 10⁻⁵ |

Loss tangent of these dielectrics was measured at 145 GHz.

For a good conductor, like copper, the term

$$\frac{ρ}{ω {ε}^{′}} ≫ 1 and \frac{{ε}^{″}}{{ε}^{′}} = 0.$$

Therefore, the depth of penetration becomes:

$${d}_{p} = \sqrt{\frac{2}{ω μ σ}}$$

The electromagnetic wave with frequency ω will only penetrate into a conductor at a depth of dₚ and is mostly reflected. On the other hand, a dielectric will allow the wave to pass through the material with attenuation tan δ.

Accordingly, one skilled in the art will appreciate, materials may be characterized according to the extent to which they conduct electricity (i.e., conductivity) and the extent to which they interact with, absorb, or transmit, electromagnetic waves via dipole reorientations (i.e., permittivity). Metals such as copper, silver, and brass exhibit relatively small levels of permittivity while being extremely good conductors. Contrariwise, dielectric materials such as Boron Nitride, Silicon Nitride, Plasma-assisted chemical vapor deposition (PACVD) diamond-like carbon coatings, and sapphire (i.e., aluminum oxide) exhibit very little, if any, conductivity while having relatively high levels of permittivity. Thus, materials with high conductivity mostly reflect microwaves, with a depth of penetration decreasing with increasing frequency, whereas dielectrics mostly absorb microwaves and/or allow them to pass. Additionally, one skilled in the art will also appreciate the condition of the materials affects their conductivity and permittivity properties. For example, after a metal is ground into a powder, the amount of absorbed electromagnetic energy typically increases while the amount of reflected energy typically decreases.

FIG. 4 shows controller 101 in further exemplary detail. Controller 101 is for example a computer that includes a memory 402, a processor 404, and an interface 406 for receiving CAM data 103. Memory 402 stores software 420 that includes machine readable instructions that when executed by processor 404 provide control and functionality of system 100 as described herein. Software 420 includes a beam control algorithm 422 and a print control algorithm 424. Beam control algorithm 422 operates to process chamber characteristics 432, which defines the size, shape, and contents of chamber 105, and CAM data 103 to generate beam instructions 442 that control operation of beam shaping unit 106 for each step in generating work-piece 112. Beam control algorithm 422 may utilize a simulation model employing basic physics principles to compute necessary beam instructions 442. The simulation model is for example custom written, but its principle of operation may be similar to COMSOL or ANSYS, as known in the art. Note that the simulation could run within controller 101, or controller 101 may utilize an external server in the cloud, wherein controller 101 utilizes a high speed Internet connection to exchange data with the cloud-server.

Chamber characteristics 432 define: (a) chamber conditions, such as temperature, pressure, atmosphere, and power distribution in chamber 105, and (b) parameters related to work-piece 112. For example: a layer of material 116 (e.g., a powder with specific electromagnetic properties (ε and μ)) has been rolled on top of the printing table 114 and is ready to be sintered in accordance with the instructions defined within CAM data 103. In another example, a layer of ceramic slurry has been deposited via print head 120 onto work-piece 112 and is ready to be heat treated. In yet another example, a metallic powder has been deposited into susceptor 302 that has been deposited layer by layer, such that work-piece 112 contains a susceptor filled with one layer of powder which is ready to be processed with the microwave beam.

CAM data 103 includes an object shape 434, which defines the shape of the work-piece 112 being generated, a sequence 436 that defines steps for generating each layer 128 of work-piece 112, and instructions for control of the microwave beam during each step of the process. For example, CAM data 103 defines the three-dimensional shape of the object to be generated and the type of material for each layer 128 added to work-piece 112, wherein print control algorithm 424 processes CAM data 103 to generate print instructions 444 that control operation of printer 118 to deposit material 116 on work-piece 112, and wherein beam control algorithm 422 provides instructions to control the microwave beam for heat treatment or sintering of the materials in each layer.

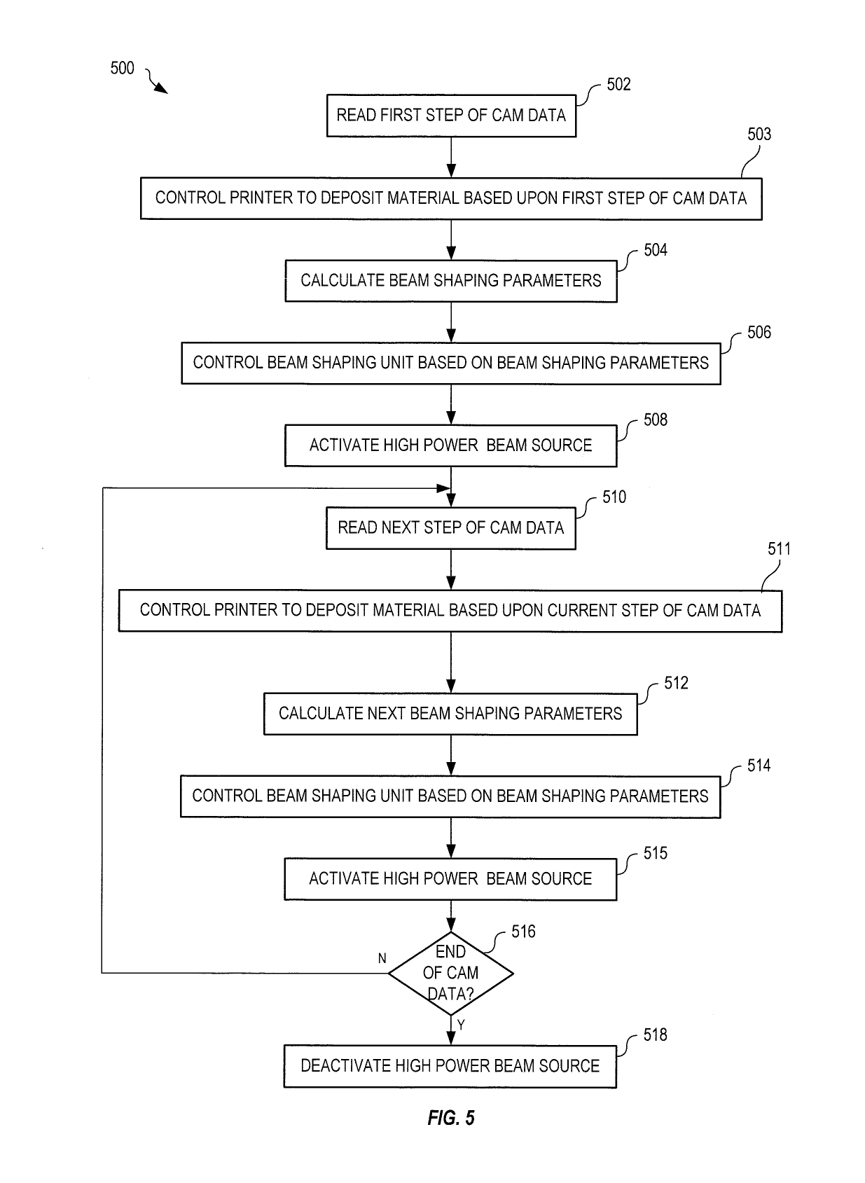

FIG. 5 is a flowchart illustrating one exemplary method 500 for microwave control during additive manufacturing. Method 500 is for example implemented within software 420 of controller 101.

In step 502, method 500 reads a first step from CAM data 103. In one example of step 502, software 420 reads information of a first step of manufacturing work-piece 112 from sequence 436 of CAM data 103. In step 503, method 500 controls the printer to deposit the material within chamber. In one example of step 503, software 420 controls, based upon the first step of CAM data 103, printer 118 to deposit material 116 onto printing table 114 within chamber 105.

In step 504, method 500 calculates beam shaping parameters. In one example of step 504, software 420 invokes beam control algorithm 422 to calculate beam instructions 442 based upon chamber characteristics 432, object shape 434, and the first step of sequence 436. Beam instructions 442 may include one or more of (i) power of the beam, (ii) time of the pulse, (iii) beam distribution on work-piece 112 (e.g., a narrow 3 mm diameter Gaussian spot with 10 kW deposited for 1 ms; or an area of 2 cm diameter with quasi-uniform distribution with 20 kW deposited for 100 ms), and (iv) frequency of the beam (if for example system 100 is multi-frequency).

In step 506, method 500 controls beam shaping unit based upon beam shaping parameters. In one example of step 506, software 420 sends beam instructions 442 from controller 101 to beam shaping unit 106. In step 508, method 500 activates the beam. In one example of step 508, software 420 sends beam characteristics defined within beam instructions 442 to integrated HPM source 102, wherein integrated HPM source 102 generates raw microwave beam 104 based upon the beam characteristics.

In step 510, method 500 reads a next step of the CAM data. In one example of step 510, software 420 reads a next step for manufacturing work-piece 112 from sequence 436 of CAM data 103. In step 511, method 500 controls the printer to deposit material based upon the current step of the CAM data. In one example of step 511, software 420 controls, based upon the current step of CAM data 103, printer 118 to deposit material 116 onto work-piece 112 and/or printing table 114 within chamber 105.

In step 512, method 500 calculates next beam shaping parameters. In one example of step 512, software 420 invokes beam control algorithm 422 to calculate beam instructions 442 based upon chamber characteristics 432, object shape 434, and the current step of sequence 436. In step 514, method 500 controls beam shaping unit based upon beam shaping parameters. In one example of step 506, software 420 sends beam instructions 442 from controller 101 to beam shaping unit 106. In step 515, method 500 activates the beam. In one example of step 515, integrated HPM source 102 generates raw microwave beam 104 based upon beam instructions 442.

Step 516 is a decision. If, in step 516, method 500 determines that the end of the CAM data has been reached, method 500 continues with step 518; otherwise, method 500 repeats steps 510 through 516.

In step 518, method 500 deactivates the high power beam source. In one example of step 518, software 420 sends a control signal to deactivate integrated HPM source 102. Method 500 then terminates.

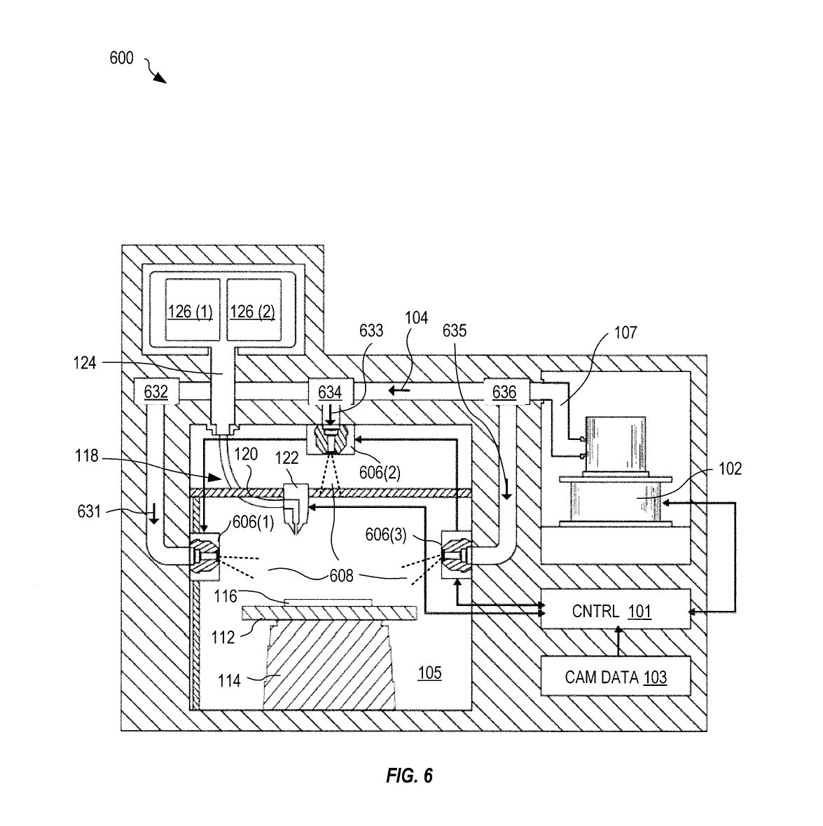

FIG. 6 shows one exemplary additive manufacturing microwave system 600 that includes one or more beam wave coupling units 632, 634, 636. System 600 is similar to system 100 of FIG. 1, but microwave energy from raw microwave beam 104, generated by integrated HPM source 102, is directed through waveguide 107 and divided into one or more divided beam components 631, 633, 635 by one or more beam wave coupling units 632, 634, 636. The one or more beam wave coupling units 632, 634, 636 are disposed and configured for directing microwave energy through beam shaping units 606. Beam shaping units 606 are examples of beam shaping unit 106 of FIG. 1. From beam shaping units 606, shaped emissions 608 are directed towards the work-piece 112 along differing axes, such as along three orthogonal axes as shown in the example of FIG. 6. Shaped emissions 608 are examples of shaped emission 108 of FIG. 1. Controller 101 may control beam wave coupling units 632, 634, 636 to generate, within chamber 105, a heating pattern (such as heating pattern 202 of FIG. 2) that supplies heating energy to desired areas of work-piece 112. Accordingly, controller 101 may apply heating within chamber 105 in a highly controllable manner so as to achieve the application of energy to work-piece 112 in precise amounts, in controlled rates, and in precise locations on and/or within deposited material 116 and work-piece 112.

In one example of operation, where a defect such as a crack is identified within work-piece 112, and where it is desirable to process the crack (e.g., fuse the crack after depositing a thin layer of powder into it) by the application of microwave energy, a combination of microwave energy beams 608 directed along two or more different axes may be provided so as to achieve a heating pattern with a desired rate of application of energy at one or more desired locations without delivering too much energy along any one of the beam axes. Thus, for example, a weld or sintering or fusing of material may be provided internally within the 3-dimensional object. Moreover, where it is desirable to provide for 3D additive manufacturing on the surface of a 3D object, and wherein the surfaces to which material is to be added may not be aligned with a single wave source, it may be advantageous to employ multiple beam wave coupling units. This capability is enabled by availability of high power (e.g., 100 kW) from an integrated microwave source 102 where the beam can be split into multiple beams with one of the beams still having extremely high energy (e.g., 50 kW).

FIG. 7 shows one exemplary additive manufacturing microwave system 700 that includes a beam controller 730. System 700 is similar to system 100 of FIG. 1, but further includes beam controller 730 to divide raw beam 104 into a plurality of separate beams that each have a beam shaping unit 706 that cooperate, under control of controller 101, to form shaped emissions 708. Shaped emissions 708 combine to form a heating pattern, such as heating pattern 202 of FIG. 2 for example, within chamber 105. The approach depicted in FIG. 7 allows greater flexibility for the microwave heating process and control over the beam distribution on work-piece 112. In one embodiment, it is beneficial for one, two, or more of beam shaping units 706 to spread the beam to provide uniform heating, while one or more beam shaping units 706 focus the beam for sintering. The energy distribution may be calculated to account for coherent/incoherent interference of multiple beams with known phase and energy properties. This enables a very precise energy maximum at a desired location, further enabling sintering of complex components.

FIG. 8 shows a schematic illustration of beam shaping unit 106 of FIG. 1 in further exemplary detail. Specifically, FIG. 8 shows a waveguide 107 used to carry raw microwave beam 104 from integrated HPM source 102. Waveguide 107 is illustratively shown with a first mirror 820 and a second mirror 830 for reflecting and manipulating raw microwave beam 104, and to guide beam 104 through the beam shaping unit 106. An exemplary embodiment shows a third mirror 840 which transmits a portion of the energy of raw microwave beam 104 and reflects a portion of the energy as shaped emission 108 into a horn 880. Third mirror 840 is movable (e.g., by rotation and/or translation) under control of controller 101. In one embodiment, transparency of third mirror 840 is adjustably controlled by controller 101 such that a controlled portion of raw microwave beam 104 passes through third mirror 840 while another portion of raw beam 104 is reflected by third mirror 840 to create shaped emission 108. The horn may include a lens 860 or any other device for active or passive control of the beam parameters. Shaped emission 108 has certain desired characteristics based upon beam instructions 442, for example.

Although beam shaping unit 106 is shown with three mirrors 820, 830, and 840, beam shaping unit 106 may include fewer or more mirrors and other components without departing from the scope hereof. For example, beam shaping unit 106 may include zero, one, or more, each of waveguides, beam shaping mirrors, horns, phase manipulators, launchers, and beam isolators without departing from the scope hereof.

Beam shaping unit 106 may also include a pump 852 for pumping, under control of controller 101 for example, a fluid through a coil 850 positioned around at least part of beam shaping unit 106. Coil 850 is shown around only part of beam shaping unit 106 for clarity of illustration but may pass around other parts of beam shaping unit 106 as desired. The fluid may be heated or cooled for heating or cooling beam shaping unit 106. Beam shaping unit 106 may include more or fewer coils 850 and pumps 852 without departing from the scope hereof.

### Examples of Use and Other Embodiments

Work-piece 112 may include two or more objects within heating chamber 105. The two or more objects may define an interface zone where the microwave energy is to be delivered, and the interface zone may be hidden beneath one or more of the objects. In accordance with an exemplary embodiment, energy may be applied in the desired location by one or more of beam shaping units 106 under control of controller 101. For example, based upon chamber characteristics 432 and object shape 434, beam control algorithm 422 determines beam instructions 442 that are used by controller 101 to control beam shaping unit 106 to generate shaped emission 108 to provide energy in the desired location.

Heating chamber 105 may include an adjustable tuner 140, such as a passive mechanical element that may be moved inside of the cavity using a rail or any other positioning mechanism. One or more tuners 140 may be used to change the geometry of heating chamber 105 enabling better control over energy distribution. The simulation model includes the adjustable tuners 140 thereby calculating the resulting energy distribution. In an embodiment, adjustable tuner 140 may be an external susceptor serving as a thermal mass that is selectively inserted into and/or withdrawn from heating chamber 105 to change the amount of energy and energy distribution within heating chamber 105. As a result, energy absorbed/reflected by the thermal mass affects the energy applied to work-piece 112.

Advantageously, the millimeter wave beam is more spread, and the energy distribution is more uniform, than a laser beam. Furthermore, a millimeter beam can penetrate deeper into the powder, such that energy may be applied not only in 2D, but also to some extent in 3D. The advantages of a larger beam area and deeper penetration include faster printing and applying heat treatment to larger objects.

In accordance with an exemplary embodiment, shaped emission 108 is focused so as to avoid unintended heating of adjacent areas, enabling in situ processing (e.g., printing and heating in the same chamber). The use of millimeter frequencies allows for very precise and adjustable control of the beam and energy distribution. This is a unique feature of millimeter waves that distinguishes radiation at these frequencies (20-180 GHz) from laser beam or from low frequency radiation such as 2.45 GHz. In addition to the above-described advantages, the invention disclosed herein may further provide effective beam shaping, penetration control, uniformity of energy distribution, decreased cost, and increased speed of production for large structures.

In an embodiment, the output power of the high power microwave source 102 is adjusted by tuning current and voltage of the electron gun inside the high power microwave source 102 that directly affects the electron current flowing inside the microwave cavity (e.g., inside a gyrotron). The change in electron current directly affects the amount of microwave energy that is created in the gyrotron and released. By controlling the magnetic field of the gyrotron system, control over the frequency of the output beam is also provided. It should be appreciated that the frequency of raw microwave beam 104 is directly related to the strength of magnetic field, which causes gyration of electrons in the electron beam current flowing inside the gyrotron cavity. The frequency is also effected by the geometry of the gyrotron's cavity such that microwaves are emitted most efficiently at certain multiples of the magnetic field.

Methods for determining chamber conditions include several known instruments. To monitor raw microwave beam 104, an infrared camera may be provided with an radio frequency (RF) filter to protect the camera lens. For real time frequency measurements, an RF diode or a harmonic mixer is provided for example. In an embodiment, one or more fluid loops are provided such that changes in temperature of the fluid may be used as an indication of power level. Instrumentation provides feedback on the application of microwave energy to the work-piece, including for example an optical pyrometer or another sensor disposed so as to observe temperatures at one or more locations on the work-piece.

The invention of this disclosure also allows fabrication of very high quality parts made of various steels, refractory metals, and ceramics.

This disclosure has been described above primarily with reference to its application in a 3D additive manufacturing system. It should be clear to one skilled in the art of material processing and additive manufacturing, however, that systems of other varied configurations and for other uses such as material processing can be envisaged without being limited to those examples provided herein.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. An additive manufacturing microwave system, comprising:
a beam shaping unit, responsive to first instructions, for manipulating raw microwave energy into shaped emission forming a first heating pattern within a heating chamber that implements desired heating of a first material deposited within the chamber; and
a controller for determining the first instructions based upon characteristics of the heating chamber and computer-aided manufacturing (CAM) data characterizing the desired heating and the first material.

2. The additive manufacturing microwave system of claim 1, the microwave energy having a wavelength between one and ten millimeters and energy above 2 kW.

3. The additive manufacturing microwave system of claim 2, the microwave energy having a wavelength between one and six millimeters and energy between 20 kW and 100 kW.

4. The additive manufacturing microwave system of claim 1, further comprising a printer capable of depositing the first material within the chamber, the controller controlling the printer to deposit the first material as defined by the CAM data.

5. The additive manufacturing microwave system of claim 1, the first material forming at least part of a work-piece.

6. The additive manufacturing microwave system of claim 1, the beam shaping unit being further responsive to second instructions for manipulating the raw microwave energy into shaped emission forming a second heating pattern within the heating chamber that implements desired heating of a second material deposited within the chamber; the controller further configured for determining the second instructions based upon the heated chamber and CAM data characterizing the second material and the desired heating of the second material.

7. The additive manufacturing microwave system of claim 6, wherein the first and second instructions are different.

8. The additive manufacturing microwave system of claim 6, the second material forming at least part of the work-piece.

9. The additive manufacturing microwave system of claim 6, further comprising a printer capable of depositing the second material within the chamber, the controller controlling the printer to deposit the second material as defined by the CAM data.

10. The additive manufacturing microwave system of claim 1, wherein the controller controls a high power microwave energy source to generate the raw microwave energy.

11. A microwave additive manufacturing method, comprising:
depositing a first material as a first layer within a heating chamber;
controlling microwave energy to form a first heating pattern at the first material to change properties of the first material and to form a first part of a work-piece;
depositing a second material as a second layer on the first part; and
controlling microwave energy to form a second heating pattern at the second material to change properties of the second material and form a second part of the work-piece.

12. The method of claim 11, the step of depositing the first material comprising:
reading a first step of CAM data;
supplying the first material from a material hopper;
moving a print head to a desired location with a print arm; and
depositing a desired amount of the first material in a desired location.

13. The method of claim 12, the step of depositing the second material comprising:
reading a second step of CAM data;
supplying the second material from a material hopper;
moving a print head to a desired location with a print arm; and
depositing a desired amount of the second material in a desired location.

14. The method of claim 11, the step of controlling microwave energy to form the first heating pattern comprising:
calculating at least one beam shaping parameter based upon at least one chamber characteristic, the work-piece, and the first material; and
controlling a beam shaping unit, based on the beam shaping parameter, to form the first heating pattern.

15. The method of claim 14, the step of controlling microwave energy to form the second heating pattern comprising:
calculating at least one beam shaping parameter based upon at least one chamber characteristic, the work-piece, and the second material; and
controlling a beam shaping unit, based on the beam shaping parameter, to form the second heating pattern.

16. The method of claim 11, the step of controlling microwave energy to form the first heating pattern comprising activating a high power microwave beam source for a first calculated period.

17. The method of claim 16, the step of controlling microwave energy to form the second heating pattern comprising activating the high power microwave beam source for a second calculated period.

18. A software product comprising instructions, stored on non-transitory computer-readable media, wherein the instructions, when executed by a computer, perform steps for implementing microwave additive manufacturing, comprising:
instructions for controlling a printer to deposit a first material within a heating chamber based upon a first step of computer-aided manufacturing (CAM) data; and
instructions for controlling a beam shaping unit to form microwave energy with a first heating pattern corresponding to the first material to change properties of the first material to form a first part of a work-piece based upon the CAM data, characteristics of a heating chamber.

19. The software product of claim 18, the instructions for controlling the beam shaping unit comprising instructions for modeling distributed energy within the heating chamber as a function of adjustable tuners that change geometry of the heating chamber to control distribution of the microwave energy.

20. A microwave additive manufacturing method, comprising:
depositing a first material within a heating chamber;
controlling microwave energy to form a first heating pattern at the first material to change properties of the first material and to form a susceptor;
depositing a second material as a second layer proximate the susceptor; and
controlling microwave energy to form a second heating pattern to heat the susceptor, wherein heat is transferred from the susceptor to the second material to change properties of the second material and form a first part of a work-piece.

21. The method of claim 20, the step of depositing the first material comprising:
depositing the first material as a first layer; and
controlling the microwave energy to change properties of the first layer of first material to form the susceptor;
repeating the steps of depositing and controlling the microwave energy to change properties of the first layer to form the susceptor as a mold.

22. The method of claim 21, the step of depositing the second material comprising depositing the second material within the susceptor, and the step of controlling microwave energy to form the second heating pattern comprising heating the second material within the susceptor, wherein the susceptor molds the second material.

23. The microwave additive manufacturing method of claim 20, further comprising:
depositing a first material and a second material within a heating chamber as a single layer; and
controlling microwave energy to form a first heating pattern at the single layer to change properties of the first and second materials to form at least part of a work-piece with bonded first and second materials.
